(19) United States
(12) Patent Application Publication
(10) Pub. No.: US 2026/0153918 A1
(43) Pub. Date: Jun. 4, 2026

(54) METHODS AND APPARATUS FOR POWER CONTROL DURING MEDIA PLAYBACK

(71) Applicant: Intel Corporation, Santa Clara, CA (US)

(72) Inventors: Anil Kumar Oruganti, Beaverton, OR (US); Kiran Mahesh Eriki, Portland, OR (US); Swathi Nukala, Portland, OR (US); Shanmuganathan Kandanathan, Portland, OR (US); Purushotam Chandan, Beaverton, OR (US)

(21) Appl. No.: 19/431,704

(22) Filed: Dec. 23, 2025

(51) Int. Cl. G06F 1/3231

(52) U.S. Cl. CPC G06F 1/3231

(57) ABSTRACT

Systems, apparatus, articles of manufacture, and methods to implement power control during media playback are disclosed. An example disclosed system manages power consumption of media engine circuitry in a compute device during media playback by monitoring both media playback status and human presence. Human presence may be determined through interface events and camera-based face detection combined with an engagement condition. When media playback is active and a valid human presence is detected, the media engine operates in an active state, enabling decoding, post-processing and buffering. When playback is active, but no valid human presence is detected, the media engine remains in a low power state by keeping the decoder active for frame timing but disabling post-processing and buffering, dropping frames. This selective power state control enables efficient energy use of the compute device and its display while maintaining appropriate media delivery.

### BACKGROUND

Compute devices, such as personal computers, notebook computers, tablet computers, etc., may include media engine circuitry to support media playback by the compute device. The media engine circuitry of a compute device may process media data, such as video data and/or image data, from application(s) on the compute device and provide the processed media data to one or more display devices coupled to and/or integrated in the compute device for presentation. The processing performed by the media engine circuitry may include video and/or image frame decoding (collectively referred to as frame decoding) and other post-processing operations.

### BRIEF DESCRIPTION OF THE DRAWINGS

FIG. 1 is a block diagram of an example compute device structured to perform power control during media playback in accordance with teachings of this disclosure.

FIG. 2 illustrates an example engagement condition used by the compute device 105 of FIG. 1 to perform power control during media playback in accordance with teachings of this disclosure.

FIG. 3 illustrates example media playback operation during different power states configured by the compute device of FIG. 1.

FIG. 4 is a block diagram of an example media engine power controller included in the compute device of FIG. 1 to perform power control during media playback in accordance with teachings of this disclosure.

FIGS. 5-7 are flowcharts representative of example machine-readable instructions and/or example operations that may be executed, instantiated, and/or performed by example programmable circuitry to implement the media engine power controller of FIG. 4.

FIG. 8 is a block diagram of an example processing platform including programmable circuitry structured to execute, instantiate, and/or perform the example machine-readable instructions and/or perform the example operations of FIGS. 5-7 to implement the media engine power controller of FIG. 4.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine-readable instructions of FIGS. 5-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Media engine circuitry is included in many types of compute devices to support playback of media, such as video data and/or image data, from one or more applications executing on the compute device. For examples, applications, such as streaming applications, gaming applications, teleconferencing applications, media player applications, etc., executing on a compute device may access and/or generate video data to be displayed by one or more display devices coupled to and/or integrated in the compute. For example, a streaming application may access (e.g., download, stream, etc.) video data from a remote server, cloud service, etc., for presentation by one or more display devices of the compute device. As another example, a media player application may access (e.g., read) local video data (e.g., a video file) stored at the compute device for presentation by one or more display devices of the compute device. The media engine circuitry of a compute device may process video data from the application(s) to yield processed video data suitable for presentation by the display device. For example, the processing performed by the media engine circuitry may include video frame decoding and other post-processing operations, such as color balancing, denoising, format conversion, super resolution conversion, etc.

Typically, the media engine circuitry of a compute device operates in an active power state during media playback. Furthermore, the media engine circuitry typically remains in the active power state during media playback regardless of whether a human is present and engaged with the media playback. For example, once a human user causes a streaming application to initiate playback of a video by a compute device, such as a movie or television program, the media engine circuitry remains in its active power state to process the video and provide the processed video to the display device even if the human user leaves a vicinity of the compute device and/or is otherwise no longer engaged with the video playback. Thus, such media engine circuitry continues to consume full power in its active power state to support media playback when no one is present and engaged with the media presentation.

Example power control solutions disclosed herein enable efficient (e.g., reduced) power consumption by media engine circuitry through implementation of power control during media playback based on human presence. In at least some example power control solutions disclosed herein, a power state of the media engine circuitry is controlled (e.g., set, configured, etc.) based on a combination of media playback status and human presence status associated with the compute device. For example, a disclosed example power control solution may cause the media engine circuitry to operate in an active power state based on the media playback status indicating media playback associated with the compute device is active and the human presence status indicates a valid human presence associated with the compute device has been detected (e.g., human presence detection is positive). However, the example power control solution may cause the media engine circuitry to operate in a low power state based on the media playback status indicating media playback is active and the human presence status indicating a valid human presence has not been detected (e.g., human presence detection is negative). In some examples, human presence associated with the compute device is considered valid (e.g., human presence detection is positive) if a human presence is detected and determined to be associated with engagement with the media playback. Conversely, in some examples, human presence associated with the compute device is considered invalid (e.g., human presence detection is negative) if a human presence is not detected, or a human presence is detected but not associated with engagement with the media playback.

As disclosed in further detail below, in at least some examples, a positive human presence status, which indicates a valid human presence associated with the compute device has been detected, is based on detection of human interface events, which may be generated in response to user interaction with a user interface device, such as a mouse, a keyboard, a stylus, a touchscreen, etc., and which indicate user engagement with the media playback. In some examples, a positive human presence status additionally or alternatively is based on detection of a human face in camera data from a camera associated with the compute device, as well as a determination that the human face satisfies an engagement condition that indicates user engagement with the media playback. In both such examples, a positive human presence status is based on not only a person's physical presence in a vicinity of the compute device (e.g., in front of the compute device) but also an indication that the person is engaged in the media playback (e.g., corresponding to interaction with a user interface device or the person's face satisfying the engagement condition).

In contrast, in at least some examples, a negative human presence status, which indicates a valid human presence associated with the compute device has not been detected or, in other words, there is an invalid human presence associated with the compute device, is based on a determination that no human interface events have been detected within a timeout period and a human face satisfying the engagement condition has not been detected in the camera data associated with the compute device. As such, a negative human presence status indicates that there is no human present in the vicinity of the compute device (e.g., in front of the compute device), or a human may be present but there is no indication that the person is engaged in the media playback. In both such examples, power control solutions disclosed herein can control the media engine circuitry to transition to a low power state and conserve power, thereby enhancing the power efficiency of the compute device. In some examples, the media engine circuitry maintains video frame timing (e.g., by keeping its decoder functionality enabled) but disables other video data processing and drops the video frames, thereby causing them not to be buffered for delivery to the display device. Such operation may further cause the display device to transition to its own low power state (e.g., due to video frames not being received from the compute device), which further conserves power and, therefore, further enhances the power efficiency of the overall system including the compute device and display device.

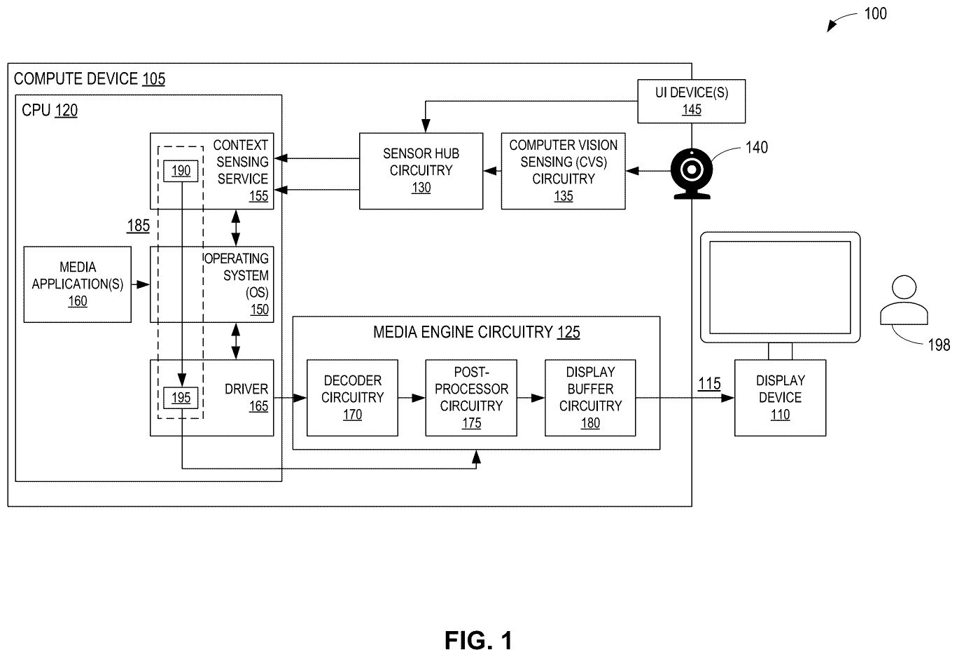

FIG. 1 is a block diagram of an example compute system 100 in which an example compute device 105 is structured to perform power control during media playback in accordance with teachings of this disclosure. The compute system 100 of FIG. 1 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSC), etc. Additionally or alternatively, the compute system 100 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

The example system 100 of FIG. 1 may be any type of compute system capable of generating and displaying image and/or video data. For example, the compute system 100 may be a personal computer, a notebook computer, a server, a smartphone, a media device, etc. The compute system 100 includes the example compute device 105 and an example display device 110. The compute device 105 of the illustrated example can be any type of compute device capable of generating or otherwise providing image and/or video data to be displayed. For example, the compute device 105 may be a CPU, a GPU, a system board (e.g., a motherboard), a personal computer, a notebook computer, a server, a smartphone, a media device, etc. The display device 110 of the illustrated example may be any type of display device capable of displaying image and/or video data. For example, the display device 110 may be a computer monitor, a television, a touchscreen display, etc. In some examples, the compute device 105 and the display device 110 are separate devices (e.g., with separate housings, chassis, etc.). In some examples, the compute device 105 and the display device 110 are integrated into the compute system 100 (e.g., included in a same housing, chassis, etc.).

In the illustrated example system 100 of FIG. 1, the compute device 105 generates pixel data corresponding to an image or video frame to be displayed by the display device 110, and sends the pixel data to the display device 110 via an example interface 115. The interface 115 of the illustrated example can be any type of interface capable of sending (e.g., transmitting) pixel data from the compute device 105 to the display device 110. For example, the interface 115 may be High-Definition Multimedia Interface (HDMI), DisplayPort (DP), Digital Visual Interface (DVI), Video Graphics Array (VGA), Universal Serial Bus (USB), etc., and/or any other wired and/or wireless interface, and/or combination thereof.

The compute device 105 of the illustrated example includes example central processing unit (CPU) circuitry 120, example media engine circuitry 125, example sensor hub circuitry 130, example computer vision sensing (CVS) circuitry 135, an example camera 140 and one or more examiner user interface devices 145. The CPU 120 of the illustrated example includes (e.g., executes) an example operating system (OS) 150, an example context sensing service 155, one or more example media applications 160 and an example driver 165 to interface between the CPU 120 and the media engine circuitry 125. The media engine circuitry 125 of the illustrated example includes example decoder circuitry 170, example post-processor circuitry 175 and example display buffer circuitry 180 to process media data (e.g., video data, image data, etc.) from the media application(s) 160 and provide the processed media data to the display device 110 via the interface 115. The compute device 105 of the further includes an example media engine power controller 185 to perform power control of the media engine circuitry 125 during media playback based on human presence detection in accordance with teachings of this disclosure.

The context sensing service 155 of the illustrated example includes or otherwise implements an example human presence detector 190 to determine human user presence status for the media engine power controller 185. As such, in the illustrated example, the human presence detector 190 is a component of the media engine power controller 185. In some examples, the context sensing service 155 corresponds to, or is included in, example context switching technology associated with the CPU 120 to enable the CPU 120 to perform context switching based on user presence.

In the illustrated example, the context sensing service 155 interfaces with the sensor hub circuitry 130 to obtain event data that can be used to determine human presence. For example, the sensor hub circuitry 130 may generate human interface events in response to user interaction with one or more of the user interface devices 145. In some examples, the user interface device(s) 145 in communication with the sensor hub circuitry 130 include one or more of a mouse, a keyboard, a stylus, a touchscreen, etc., and the sensor hub circuitry 130 generates a human interface event based on (e.g., in response to) user interaction with the mouse (e.g., movement and/or clicking of the mouse), interaction with the keyboard (e.g., typing on the keyboard), interaction with the stylus (e.g., movement of the stylus), and/or interaction with the touchscreen (e.g., touching of the touchscreen), etc. As such, the human interface events indicate a user is interacting with the compute device 105 and, thus, is present and engaged with the compute device 105, which corresponds to a valid human presence. In some examples, the human interface events generated by the sensor hub circuitry 130 include a time of the event and a type of the human interface interaction that caused the event.

In the illustrated example, the sensor hub circuitry 130 additionally or alternatively generates face detection events based on (e.g., in response to) detection of a human face in camera data captured and provided by the camera 140. The compute device 105 of the illustrated example includes the CVS circuitry 135, which is in communication with the camera 140 and the sensor hub circuitry 130, to detect human faces in camera data, such as image data, video data, etc., captured by the camera 140. The camera 140 of the illustrated camera 140 may be integrated in the compute device 105 (e.g., such as an integrated camera) or separate from but coupled to the compute device 105 (e.g., such as a separate camera accessory), but is positionable to capture camera data including images and/or video of an example human user 198 of the compute device 105. The CVS circuitry 135 of the illustrated example implements one or more machine learning algorithms to detect faces in the camera data from the camera 140. The CVS circuitry 135 of the illustrated example also determines an orientation of the detected face relative to an image plane of the camera 140. In the illustrated example, the sensor hub circuitry 130 generates a face detection event in response to successful detection of a human face by the CVS circuitry 135. In some examples, the face detection events generated by the sensor hub circuitry 130 include a time of the event and a description of the orientation of the detected face associated with the event. In the example of FIG. 1, the CVS circuitry 135 is illustrated as being integrated in the compute device 105. However, in some examples, the CVS circuitry 135 and/or its machine learning algorithm(s) may be integrated in a camera subsystem including the camera 140, implemented by the sensor hub circuitry 130, implemented as an example peripheral or addon device coupled to the compute device 105, etc.

The human presence detector 190 of the illustrated example determines human presence status based on the event data generated by the sensor hub circuitry 130. For example, the human presence detector 190 determines human presence status based on the human interface events and/or the face detection events generated by the sensor hub circuitry 130. In some examples, the human presence detector 190 monitors for the human interface events from the sensor hub circuitry 130 to generate or otherwise obtain a human interface event status associated with the compute device 105 at a particular time. In some such examples, the human interface event status indicates whether a human interface event has been generated within a human interface timeout period, which may be predetermined, user configurable, application configurable, etc. For example, the human interface timeout period may be 5 seconds or some other duration, and the human presence detector 190 may restart the human interface timeout period when a new human interface event is generated.

In some examples, the human presence detector 190 monitors for the face detection events from the sensor hub circuitry 130 to generate or otherwise obtain a face detection event status associated with the compute device 105 at a particular time. In some such examples, the face detection event status indicates whether a face detection event, which indicates a human face has been detected in the camera data from the camera 140, has been generated within a face detection timeout period and, if so, whether the detected face satisfies an engagement condition. In some examples, the face detection timeout period may be predetermined, user configurable, application configurable, etc. For example, the face detection timeout period may be 5 seconds or some other duration, and the human presence detector 190 may restart the face detection timeout period when a new face detection event is generated and the detected face associated with the face detection event is determined to satisfy the engagement condition. In some examples, the human interface timeout period and the face detection timeout period may be a same timeout period or different timeout periods.

In the illustrated example, the human presence detector 190 determines the human presence status associated with the compute device 105 based on the human interface event status and the face detection event status. In some examples, the human presence detector 190 sets the human presence status to indicate human presence detection associated with the compute device 105 is positive (e.g., a valid human presence associated with the compute device 105 has been detected) based on a determination that the human interface event status indicates a human interface event associated with the compute device 105 has been generated within the human interface timeout period. In some examples, the human presence detector 190 additionally or alternatively sets the human presence status to indicate human presence detection associated with the compute device 105 is positive (e.g., a valid human presence associated with the compute device 105 has been detected) based on a determination that the face detection event status indicates a face detection event associated with the compute device 105 has been generated within the face detection timeout period and the face associated with the face detection event satisfies the engagement condition. In some examples, the human presence detector 190 sets the human presence status to indicate human presence detection associated with the compute device 105 is negative (e.g., a valid human presence associated with the compute device 105 has not been detected) based on a determination that the human interface event status indicates a human interface event associated with the compute device 105 has not been generated within the human interface timeout period and the face detection event status indicates a face detection event associated with a face that satisfies the engagement condition has not been generated within the face detection timeout period.

In some examples, the human presence detector 190 sets the human presence status based on human interface event status without determining or otherwise obtaining the face detection event status so long as the human interface event status indicates a human interface event associated with the compute device 105 has been generated within the human interface timeout period. However, in some such examples, when the human interface event status indicates no human interface event associated with the compute device 105 has been generated within the human interface timeout period, the human presence detector 190 switches to setting the human presence status based on the face detection event status. In some examples, the human presence detector 190 continues using the face detection event status to set the human presence status until the human interface event status indicates a new human interface event has been generated, at which time the human presence detector 190 switches back to setting the human presence status based on human interface event status.

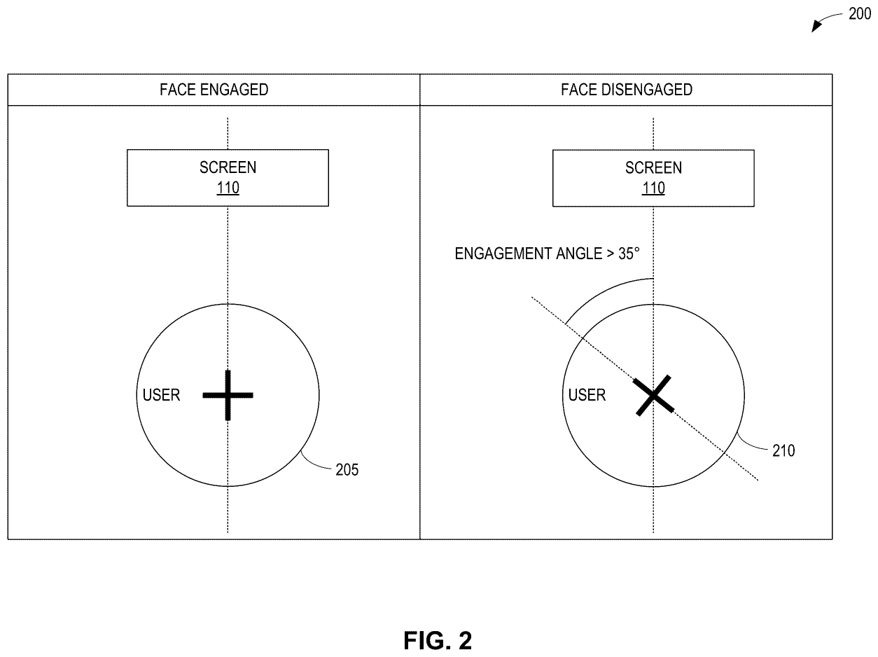

FIG. 2 illustrates an example engagement condition 200 utilized by the human presence detector 190 to evaluate face detection events. As described above, example face detection events generated by the sensor hub circuitry 130 correspond to successful face detections in the camera data from the camera 140 and specify a time of the face detection event and a description of the orientation of the detected face associated with the event. The engagement condition 200 of the illustrated example considers a detected face to be engaged with the compute device 105 when the detected face is oriented directly at the display device 110 or has an orientation angled away from the direction of the display device 110 but within a threshold engagement angle relative to the direction of the display device 110. For example, the threshold engagement angle may be 35 degrees or some other value. Conversely, the engagement condition 200 of the illustrated example considers a detected face to be disengaged with the compute device 105 when the detected face is has an orientation angled away from the direction of the display device 110 by an amount that exceeds the threshold engagement angle.

Thus, in some examples, the human presence detector 190 determines a detected face satisfies the engagement condition 200 when the detected face has an orientation withing a threshold engagement angle from the direction of the display device 110 (or from the direction of the focal plane of the camera 140 assuming the camera 140 is aligned with the display device 110). Conversely, in some examples, the human presence detector 190 determines a detected face does not satisfy the engagement condition 200 when the detected face has an orientation angled away from the direction of the display device 110 (or the direction of the focal plane of the camera 140 assuming the camera 140 is aligned with the display device 110) by an amount that exceeds the threshold engagement angle. FIG. 2 illustrates an example detected face 205 that satisfies the engagement condition and an example detected face 210 that does not satisfy the engagement condition.

Returning to FIG. 1, the driver 165 of the illustrated example includes or otherwise implements an example media playback power controller 195 to implement a power control algorithm for the media engine circuitry 125 based on human presence status and media playback status. As such, in the illustrated example, the media playback power controller 195 is a component of the media engine power controller 185.

In the illustrated example, the media playback power controller 195 obtains the human presence status associated with the compute device from the human presence detector 190 via the OS 150. The media playback power controller 195 of the illustrated example also operates to detect the media playback status of the compute device 105. In some examples, the media playback power controller 195 determines the media playback status of the compute device 105 based on detecting or otherwise determining that the driver 165 is has been configured (e.g., called, programmed, invoked, etc.) to provide media data (e.g., image data, video data, etc.) from an active application 160 to the media engine circuitry 125.

For example, the active application 160 may be a streaming application, a gaming application, a teleconferencing application, etc., that accesses and/or generates video data to be displayed by the display device 110. In some examples, the active application 160 configures (e.g., calls, programs, invokes, etc.) the driver 165 to cause the video data to be provided from the active application 160 to the media engine circuitry 125 so that the media engine circuitry 125 can process the video data and provide the process video data to the display device 110. In some such examples, the media playback power controller 195 sets the media playback status of the compute device 105 to indicate media playback is active (or enabled, on, etc.) if the driver 165 has been configured to cause media data (e.g., image data, video data, etc.) to be provided from the active application 160 to the media engine circuitry 125. In other words, in some such examples, the media playback power controller 195 sets the media playback status of the compute device 105 to indicate media playback is active (or enabled, on, etc.) if the media playback power controller 195 detects there is media data to be provided from the active application 160 to the media engine circuitry 125. Conversely, in some such examples, the media playback power controller 195 sets the media playback status of the compute device 105 to indicate media playback is inactive (or disabled, off, etc.) if the driver 165 has not been configured to cause media data (e.g., image data, video data, etc.) to be provided from the active application 160 to the media engine circuitry 125. In other words, in some such examples, the media playback power controller 195 sets the media playback status of the compute device 105 to indicate media playback is inactive (or disabled, off, etc.) if the media playback power controller 195 does not detect there is media data to be provided from the active application 160 to the media engine circuitry 125.

In some examples, the media playback power controller 195 further determines the media playback status of the compute device 105 based on identification of the active application 160 on the compute device 105. For examples, the media playback power controller 195 may identify the active application 160 based on information, such as process identification information, obtained from the OS 150 based on a system call, a query, etc. In some such examples, the media playback power controller 195 determines whether the active application 160 is capable of initiating a media playback based on the identity or identifier of the active application 160 (e.g., by comparing the identify/identifier to a reference identification information specifying a collection of applications capable of media playback). In some such examples, the media playback power controller 195 then determines the media playback status of the compute device based on a combination of detection of media data to be provided from the active application 160 to the media engine circuitry 125 and identification of the active application 160. For example, the media playback power controller 195 may set the media playback status of the compute device 105 to indicate media playback is active (or enabled, on, etc.) if the media playback power controller 195 detects there is media data to be provided from the active application 160 to the media engine circuitry 125 and identifies the active application 160 is capable of or otherwise associated with media playback. Conversely, in some examples, the media playback power controller 195 sets the media playback status of the compute device 105 to indicate media playback is inactive (or disabled, off, etc.) if the media playback power controller 195 does not detect there is media data to be provided from the active application 160 to the media engine circuitry 125 or if the media playback power controller 195 identifies the active application 160 is not capable of or otherwise associated with media playback

As described above, the media playback power controller 195 operates to control (e.g., configure, set, etc.) a power state (also referred to as a power mode) of the media engine circuitry 125 based on a combination of the media playback status and the human presence status of the compute device 105. In some examples, the media playback power controller 195 causes the media engine circuitry 125 to operate in an active power state based on the media playback status indicating media playback associated with the compute device 105 is active and the human presence status indicating a valid human presence associated with the compute device 105 has been detected (e.g., human presence detection is positive). For example, the media playback power controller 195 may cause the media engine circuitry 125 to operate in the active power state by controlling, configuring, setting, etc., an appropriate power control function/feature provided by the driver 165. However, in some examples, the media playback power controller 195 causes the media engine circuitry 125 to operate in a low power state based on the media playback status indicating media playback associated with the compute device 105 is active and the human presence status indicating a valid human presence associated with the compute device 105 has not been detected (e.g., human presence detection is negative). For example, the media playback power controller 195 may cause the media engine circuitry 125 to operate in the low power state by controlling, configuring, setting, etc., an appropriate power control function/feature provided by the driver 165.

In the illustrated example of FIG. 1, the media engine circuitry 125 includes the example decoder circuitry 170 to implement any appropriate media decoder or decoders (e.g., video decoder(s), image decoder(s), etc.) to decode encoded media data (encoded video data, encoded image data, etc.) from the active application 160 to obtain decoded media data (decoded video data, decoded image data, etc.). In some example, the decoder circuitry 170 also includes timing circuitry to maintain frame timing in the compute device. For example, such frame timing may specify when decoded video frames are to be provided by the media engine circuitry 125 to the display device 110 to satisfy a frame rate of the display device 110. The media engine circuitry 125 of the illustrated example also includes the example post-processor circuitry to perform post-processing operations, such as color balancing, denoising, format conversion, super resolution conversion, etc., on the decoded media data to obtain corresponding processed media data (e.g., processed video data, processed image data, etc.). The media engine circuitry 125 of the illustrated example further includes the example display buffer circuitry 180 to implement a display buffer to store processed media frames (e.g., processed video frames, processed image frames, etc.) to be provided (e.g., sent, transmitted, etc.) to the display device 110 via the interface 115.

In some examples, controlling or otherwise causing the media engine circuitry 125 to operate in the active power state causes the media engine circuitry 125 to activate and operate the decoder circuitry 170, the post-processor circuitry 175 and the display buffer circuitry 180 at full power. For example, the active power state may correspond to a power on state, a working state, etc., or any other active power state. However, in some examples, the controlling or otherwise causing the media engine circuitry 125 to operate in the low power state causes the media engine circuitry 125 to activate the decoder circuitry 170 but deactivate the post-processor circuitry 175 and/or the display buffer circuitry 180, or operate the post-processor circuitry 175 and/or the display buffer circuitry 180 at reduced power (e.g., by disabling one or more features of the post-processor circuitry 175 and/or the display buffer circuitry 180). For example, the low power state may correspond to an idle power state, a sleep power state, a standby power state, etc., or any other low power state.

In the illustrated example, the media engine circuitry 125 converses power when controlled by the media playback power controller 195 to operate in the low power state. Furthermore, the media engine circuitry 125 of the illustrated example maintains video frame timing in the low power state (e.g., by keeping the decoder circuitry 170 enabled) but disables other video data processing and drops the video frames (e.g., by disabling at least the post-processor circuitry 175 and potentially the display buffer circuitry 180), thereby causing the dropped frame not to be buffered for delivery to the display device 110. Such operation may further cause the display device 110 to transition to its own low power state (e.g., due to video frames not being received from the compute device 105), which further conserves power and, therefore, enhances the power efficiency of the overall system 100.

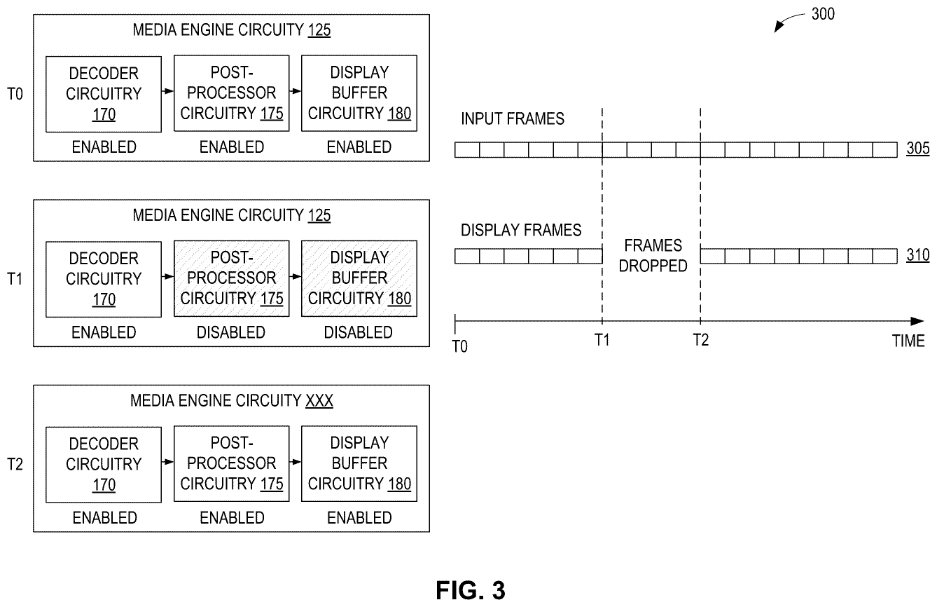

To further illustrate the benefit of power control of the media engine circuitry 125 based on human presence detection, FIG. 3 illustrates example media playback operation 300 of the media engine circuitry 125 during different power states configured by the media engine power controller 185 of the compute device 105 of FIG. 1. The media playback operation 300 of the illustrated example begins at time TO with the media engine circuitry 125 configured by the media engine power controller 185 to operate in the active power state because the active application 160 has initiated media playback and the media engine power controller 185 has determined the human presence detection status of the compute device 105 is positive. As a result of being in the active power state, the decoder circuitry 170, the post-processor circuitry 175 and the display buffer circuitry 180 of the media engine circuitry 125 are enabled and able to process example input frames 305 of media data from the active application 160 to produce corresponding example display frames 310 of processed media data to be provided to the display device.

In the media playback operation 300 of the illustrated example, the media engine circuitry 125 continues to operate in the active power state until time T1. In the illustrated example, at time T1, the media engine power controller 185 determines the human presence detection status of the compute device 105 is negative (e.g., because a human interface event associated with the compute device 105 has not been generated within the human interface timeout period and a face detection event associated with a face that satisfies the engagement condition has not been generated within the face detection timeout period, as described above). Based on this determination, the media engine power controller 185 controls the media engine circuitry 125 to operate in the low power state. As a result of being in the low power state, the decoder circuitry 170 of the media engine circuitry 125 remains enabled to maintain frame timing, but the post-processor circuitry 175 and the display buffer circuitry 180 of the media engine circuitry 125 are disabled. Thus, the input frames 305 beginning at time T1 are dropped and no corresponding display frames are provided to the display device 110.

In the media playback operation 300 of the illustrated example, the media engine circuitry 125 continues to operate in the low power state until time T2. In the illustrated example, at time T2, the media engine power controller 185 determines the human presence detection status of the compute device 105 is positive (e.g., because a new human interface event associated with the compute device 105 has been generated within the human interface timeout period or a face detection event associated with a face that satisfies the engagement condition has been generated within the face detection timeout period, as described above). Based on this determination, the media engine power controller 185 controls the media engine circuitry 125 to operate in the active power state. As a result of being in the active power state, the decoder circuitry 170, the post-processor circuitry 175 and the display buffer circuitry 180 of the media engine circuitry 125 are enabled and able to resume processing of the input frames 305 to produce corresponding display frames 310 to be provided to the display device.

Returning to FIG. 1, in some examples, the compute device 105 implements adaptive dimming to adjust the screen brightness of the display device based on detected light conditions and user interactions. Adaptive dimming can enhance the user experience by providing adequate screen visibility without compromising on the battery of the compute device 105. In some examples, the CVS circuitry 135 obtains the lighting conditions from an ambient light sensor, obtains user alertness/engagement from a human user presence sensor, obtains a distance of the user to the compute device 105 from a proximity sensor, implements a machine learning algorithm to alter the brightness and refresh rate of the screen of the display device 110.

For example, the compute device 105 utilize the context sensing service 155 to detect user presence for adaptive dimming. In some examples, the context sensing service 155 implements a virtual biometric sensor to obtain a user presence stream from CVS circuitry 135 via the sensor hub circuitry 130. In some examples, the context sensing service 155 also continuously monitors for human interface events on the compute device 105. If there are no human interface events within a given timeout period (e.g., 5 seconds or some other duration), the context sensing service 155 proceeds to check the data provided by the virtual biometric presence sensor to detect human presence.

For example, upon detecting a face within the engagement angle in the data provided by the virtual biometric presence sensor, the context sensing service 155 may restart the timeout period and indicate to the OS 150 to keep the screen of the display device 110 active (e.g., at its configured brightness). However, if the context sensing service 155 detects a face in the data provided by the virtual biometric presence sensor but the face is disengaged (e.g., outside the engagement angle), the context sensing service 155 causes the screen of the display device 110 to slowly dim to a predefined brightness until the ser re-engages. However, if the context sensing service 155 does not detect a face in the data provided by the virtual biometric presence sensor, the context sensing service 155 may slowly dim the screen of the display device 110 and then turn off the display device 110.

In some examples, if the user reappears within a predefined time, the context sensing service 155 will turn on the display device 110 and undim the screen. Also, if a human interface event is detected (e.g., besides system lock), the context sensing service 155 may quickly undim the screen of the display device 110 and reset the human interface timeout period. Notably, the compute device 105, including the media engine circuitry 125, may remain in the active power state throughout active dimming processing.

Table 1 summarizes operation of the active dimming feature.

TABLE 1

| User Presence | Face Engaged | Human Interface Event | Screen |
|---|---|---|---|
| Yes | Yes | No | Un-dim |
| Yes | No | No | Dim |
| No | No | Yes | Un-Dim |
| No | No | No | Dim |

Table 2 lists different power modes/states supported by the CVS circuitry 135 of the illustrated example.

TABLE 2

| CVS Chip | | |
|---|---|---|
| Power | | User |
| State | Condition | Presence |
| Power | Compute device 105 powered down or in | Not |
| Down | hibernate mode | Applicable |
| Ultra Low | Initialized, but could be woken up by the sensor | Not |
| Power Idle | hub circuitry 130 or an Image Processing Unit | Applicable |
| | (IPU) | |
| Ultra Low | The path to the sensor hub circuitry 130 is ready | No |
| Power | for streaming, but waiting for trigger to move to | |
| | next stage based on user presence | |
| Active | User presence has been detected, and vision | Yes |
| | algorithms are running for each frame and | |
| | streamed to the sensor hub. After there is no | |
| | face detected, the CVS chip 135 will switch to | |
| | the Ultra Low Power Mode. | |

In some examples, the human presence detector 190 of the media engine power controller 185 uses human presence information from the adaptive dimming feature to detect or augment detection of human presence associated with the compute device 105. For example, the media engine power controller 185 may implement a communication path between the context sensing service 155 and the driver 165, as shown in the example of FIG. 1, to enable human presence information determined by the adaptive diming processing flow to be provided by the context sensing service 155 to the media playback power controller 195 implemented by the driver 165.

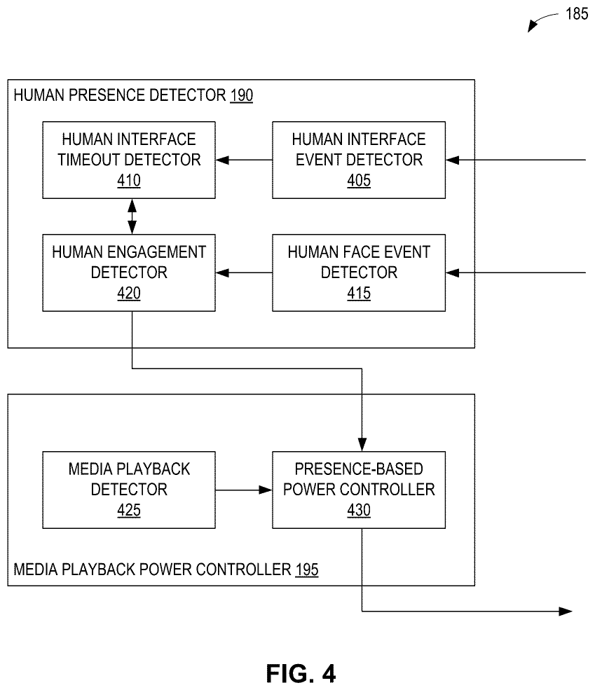

FIG. 4 is a block diagram of an example implementation of the media engine power controller 185 of FIG. 1. The media engine power controller 185 of FIG. 4 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the media engine power controller 185 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

The example media engine power controller 185 of FIG. 4 includes the example human presence detector 190 and the example media playback power controller 195. The human presence detector 190 of the illustrated example includes an example human interface event detector 405, an example human interface timeout detector 410, an example human face event detector 415 and an example human engagement detector 420. The media playback power controller 195 of the illustrated example includes an example media playback detector 425 and an example presence-based power controller 430.

As described above, the human presence detector 190 obtains a human presence status associated with the compute device. The media playback detector 425 of the media playback power controller 195 detects a media playback status of the compute device 105, as described above. The presence-based power controller 430 of the media playback power controller 195 then controls a power state of the media engine circuitry 125 based on the media playback status and the human presence status.

For example, the presence-based power controller 430 may cause the media engine circuitry 125 to operate in a low power state based on the media playback status indicating media playback is active and the human presence status indicates a valid human presence has not been detected, as described above. In some examples, the media data includes video data, and the media engine circuitry 125 is to maintain video frame timing during operation in the low power state, but drop video frames to be provided to the display device 110, as described above. For example, such operation may be achieved because the decoder circuitry 170 of the media engine circuitry 125 is to be enabled in the low power state, but at least the post-processor circuitry 175 of the media engine circuitry 125 (and potentially the display buffer circuitry 180 of the media engine circuitry 125) is to be disabled in the low power state. However, in some examples, operation in the low power state causes the media engine circuitry 125 to maintain video frame timing and causes video frames to be updated to the display buffer circuitry 180 of the media engine circuitry 125 at a reduced rate to conserve power. For example, the media engine circuitry 125 may achieve such operation in the low power state by still enabling its post-processor circuitry 175 and its display buffer circuitry 180 in the low power state, but operating them at a reduced cadence (e.g., reduced frequency, power, etc.). Furthermore, in some examples, the presence-based power controller 430 may cause media engine circuitry 125 to operate in an active power state based on the media playback status indicating media playback is active and the human presence status indicating a valid human presence has been detected, as described above. In some examples, the media playback detector 425 detects the media playback status of the compute device 105 based on detection of media data to be provided from the active application 160 of the compute device to the media engine circuitry 125.

In the illustrated example, the human engagement detector 420 of the human presence detector 190 determines the human presence status associated with the compute device 105 based on at least one of a human interface event status or a face detection event status associated with the compute device, as described above. For example, the human interface event detector 405 of the human presence detector 190 may determine the human interface event status based on detection of human interface events from the sensor hub circuitry 130, and the human face event detector 415 of the human presence detector 190 may determine the face detection event status based on face events from the sensor hub circuitry 130, as described above.

In some examples, the human engagement detector 420 sets the human presence status to indicate a valid human presence has been detected based on the human interface event status indicating a human interface event has been generated within a timeout period monitored by the human interface timeout detector 410 of the human presence detector 190, as described above. For example, the human interface events may be generated by the sensor hub circuitry 130 based on activity associated with a user interface device 145 associated with the compute device 105.

In some examples, the human engagement detector 420 sets the human presence status to indicate a valid human presence has been detected based on the face detection event status indicating a face has been detected in camera data associated with the compute device 105 and the face satisfies an engagement condition, as described above. For example, the human engagement detector 420 may determine the detected face satisfies the engagement condition based on an orientation of the face satisfying an engagement angle relative to the camera 140 that provided the camera data, as described above. In some examples, the human engagement detector 420 obtains the face detection event status after a determination that a timeout period associated with human interface events has expired.

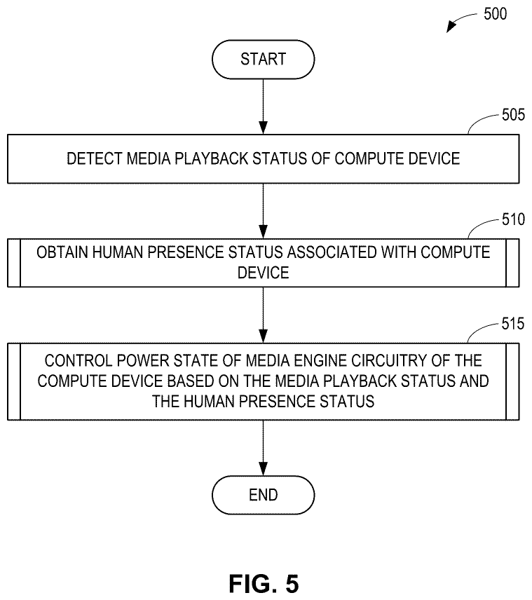

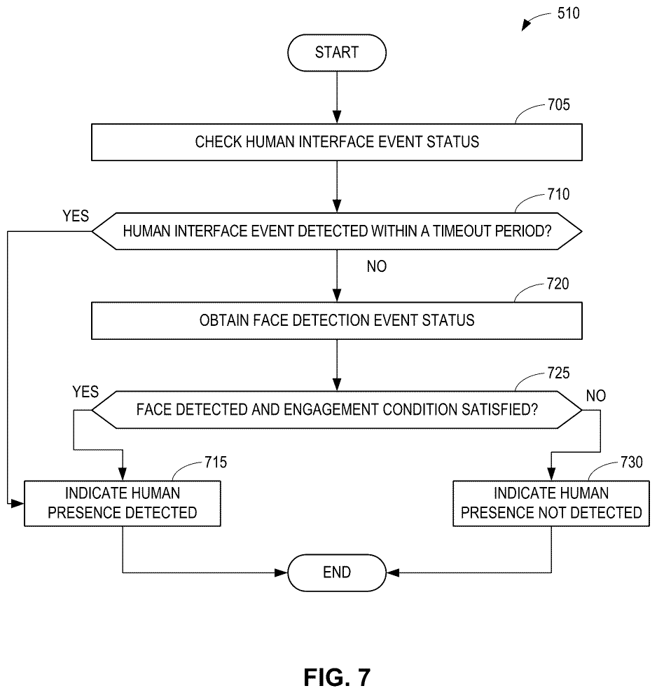

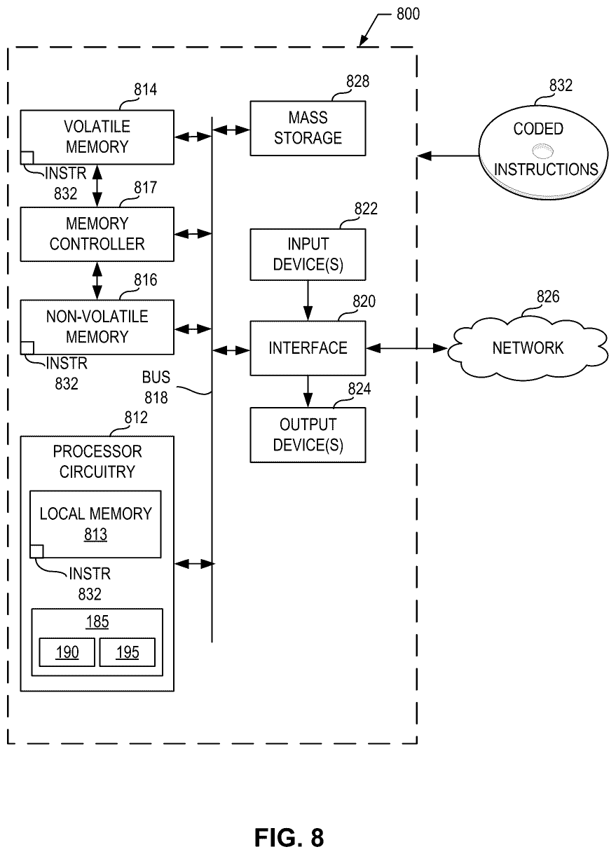

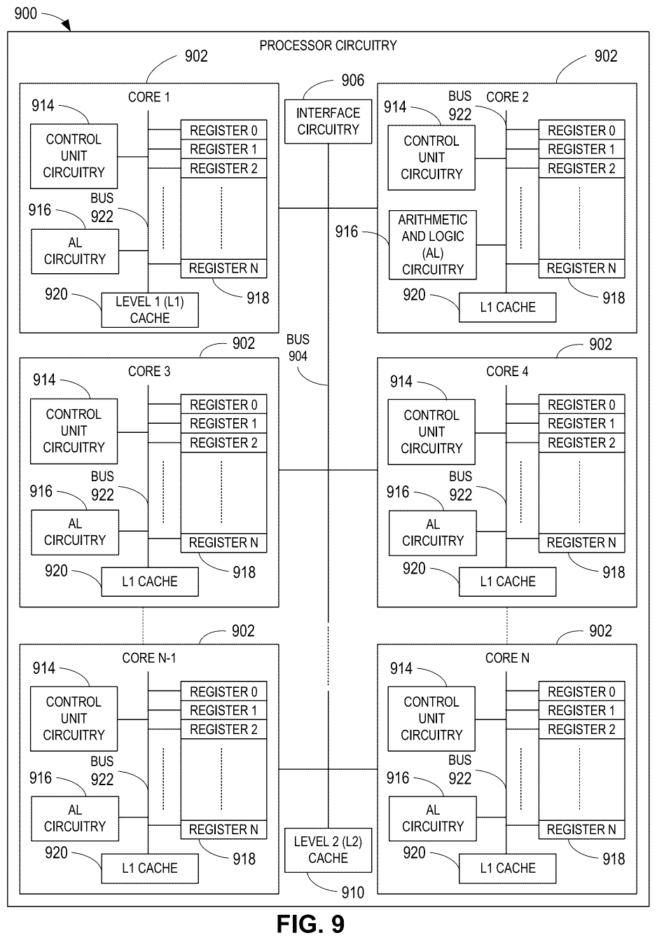

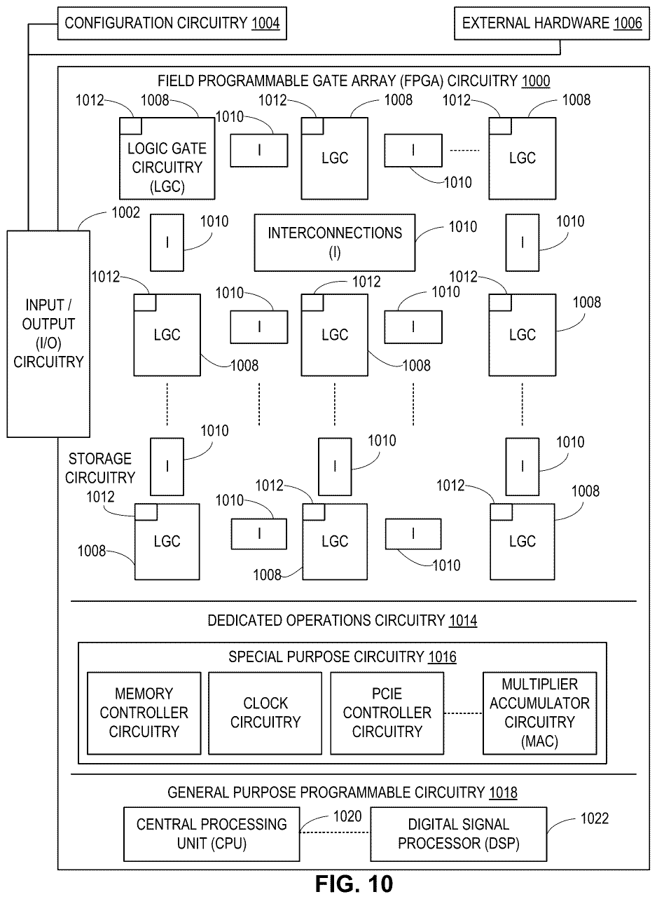

In some examples, the media engine power controller 185 includes means determining human presence associated with a compute device. For example, the means for determining human presence may be implemented by the human presence detector 190. In some examples, the human presence detector 190 may be instantiated by programmable circuitry such as the example programmable circuitry 812 of FIG. 8. For instance, the human presence detector 190 may be instantiated by the example microprocessor 900 of FIG. 9 executing machine executable instructions such as those implemented by at least blocks 510 of FIG. 5 and/or blocks 705-730 of FIG. 7. In some examples, human presence detector 190 may be instantiated by hardware logic circuitry, which may be implemented by an ASIC, XPU, or the FPGA circuitry 1000 of FIG. 10 configured and/or structured to perform operations corresponding to the machine-readable instructions. Additionally or alternatively, the human presence detector 190 may be instantiated by any other combination of hardware, software, and/or firmware. For example, the human presence detector 190 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

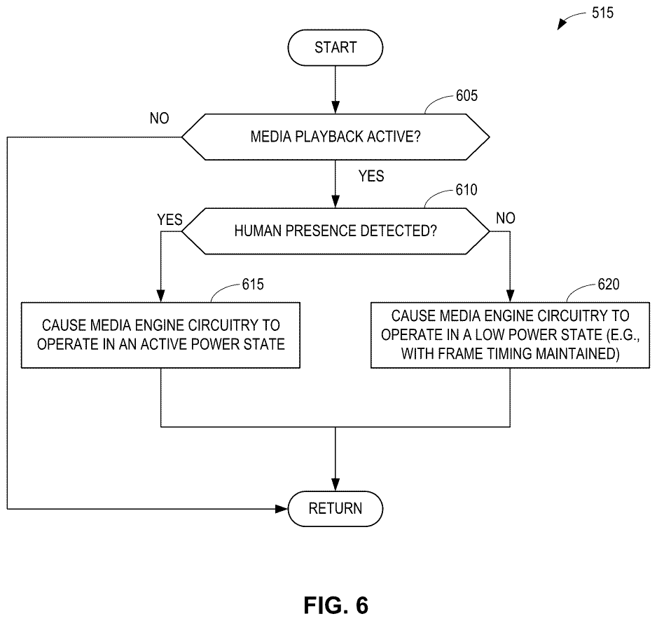

In some examples, the media engine power controller 185 includes means performing power control during media playback associated with a compute device. For example, the means for performing power control may be implemented by the media playback power controller 195. In some examples, the media playback power controller 195 may be instantiated by programmable circuitry such as the example programmable circuitry 812 of FIG. 8. For instance, the media playback power controller 195 may be instantiated by the example microprocessor 900 of FIG. 9 executing machine executable instructions such as those implemented by at least blocks 505 and/or 515 of FIG. 5 and/or blocks 605-620 of FIG. 6. In some examples, media playback power controller 195 may be instantiated by hardware logic circuitry, which may be implemented by an ASIC, XPU, or the FPGA circuitry 1000 of FIG. 10 configured and/or structured to perform operations corresponding to the machine-readable instructions. Additionally or alternatively, the media playback power controller 195 may be instantiated by any other combination of hardware, software, and/or firmware. For example, the media playback power controller 195 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the media engine power controller 185 of FIG. 1 is illustrated in FIG. 4, one or more of the elements, processes, and/or devices illustrated in FIG. 4 may be combined, divided, re-arranged, omitted, eliminated, and/or implemented in any other way. Further, the example human presence detector 190, the example media playback power controller 195, the example human interface event detector 405, the example human interface timeout detector 410, the example human face event detector 415, the example human engagement detector 420, the example media playback detector 425, the example presence-based power controller 430, and/or, more generally, the example media engine power controller 185 of FIG. 4, may be implemented by hardware alone or by hardware in combination with software and/or firmware. Thus, for example, any of the example human presence detector 190, the example media playback power controller 195, the example human interface event detector 405, the example human interface timeout detector 410, the example human face event detector 415, the example human engagement detector 420, the example media playback detector 425, the example presence-based power controller 430, and/or, more generally, the example media engine power controller 185, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example media engine power controller 185 of FIG. 4 may include one or more elements, processes, and/or devices in addition to, or instead of, those illustrated in FIG. 4, and/or may include more than one of any or all of the illustrated elements, processes and devices.

Flowchart(s) representative of example machine-readable instructions, which may be executed by programmable circuitry to implement and/or instantiate the media engine power controller 185 of FIG. 4 and/or representative of example operations which may be performed by programmable circuitry to implement and/or instantiate the media engine power controller 185 of FIG. 4, are shown in FIGS. 5-7. The machine-readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 5-7, many other methods of implementing the example media engine power controller 185 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSC), etc., and/or any combination(s) thereof in any of the contexts explained above. As used herein, the term “circuitry” refers to at least one “circuit.” Thus, circuitry refers to a circuit or a system of circuits. As used herein, programmable circuitry includes and/or corresponds to at least one programmable circuit.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 5-7 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 5 is a flowchart representative of example machine-readable instructions and/or example operations 500 that may be executed, instantiated, and/or performed by programmable circuitry to implement the media engine power controller 185 of FIGS. 1 and/or 4. The example machine-readable instructions and/or the example operations 500 of FIG. 5 begin at block 505, at which the media playback power controller 195 of the media engine power controller 185 detects a media playback status of the compute device 105, as described above. At block 510, the human presence detector 190 of the media engine power controller 185 obtains a human presence status associated with compute device 105, as described above. At block 515, the media playback power controller 195 controls a power state of the media engine circuitry 125 of the compute device 105 based on media playback status and human presence status. The example machine-readable instructions and/or the example operations 500 then end.

FIG. 6 is a flowchart representative of example machine-readable instructions and/or example operations 515 that may be executed, instantiated, and/or performed by programmable circuitry to implement the processing at block 515 of FIG. 5 and/or the media playback power controller 195 in the media engine power controller 185 of FIGS. 1 and/or 4. The example machine-readable instructions and/or the example operations 515 of FIG. 6 begin at block 605, at which the media playback power controller 195 determines whether media playback on the compute device 105 is active, as described. If media playback is active (corresponding to the “Yes” output of block 605), at block 510 the media playback power controller 195 determines, as described above, whether a valid human presence associated with the compute device 105 was detected. If a valid human presence was detected (corresponding to the “Yes” output of block 610), at block 615, the media playback power controller 195 causes the media engine circuitry 125 of the compute device 105 to operate in an active power state, as described above. However, if a valid human presence was not detected (corresponding to the “No” output of block 610), at block 620, the media playback power controller 195 causes media engine circuitry 125 to operate in a low power state (e.g., with frame timing maintained), as described above. The example machine-readable instructions and/or the example operations 515 then end.

FIG. 7 is a flowchart representative of example machine-readable instructions and/or example operations 510 that may be executed, instantiated, and/or performed by programmable circuitry to implement the processing at block 510 of FIG. 5 and/or the human presence detector 190 in the media engine power controller 185 of FIGS. 1 and/or 4. The example machine-readable instructions and/or the example operations 510 of FIG. 7 begin at block 705, at which the human presence detector 190 checks human interface event status associated with the compute device 105, as described above. At block 710, the human presence detector 190 determines whether a human interface event has been detected/generated within a timeout period, as described above. If a human interface event has been detected/generated within the timeout period (corresponding to the “Yes” output of block 710), at block 715, the human presence detector 190 sets the human presence status of the compute device 105 to indicate a valid human a valid has been detected (e.g., human presence detection is positive), as described above. The example machine-readable instructions and/or the example operations 510 then end.

However, if a human interface event has not been detected/generated within the timeout period and, thus, the timeout period has expired (corresponding to the “No” output of block 710), at block 720, the human presence detector 190 obtains face detection event status associated with the compute device 105, as described above. At block 725, the human presence detector 190 determines whether a face has been detected and, if so, whether an engagement condition has been satisfied, as described above. If a face satisfying the engagement condition has been detected (corresponding to the “Yes” output of block 725), at block 715, the human presence detector 190 sets the human presence status of the compute device 105 to indicate a valid human presence has been detected (e.g., human presence detection is positive), as described above. However, if a face satisfying the engagement condition has not been detected (corresponding to the “No” output of block 725), at block 730, the human presence detector 190 sets the human presence status of the compute device 105 to indicate a valid human presence has not been detected (e.g., human presence detection is negative), as described above. The example machine-readable instructions and/or the example operations 510 then end.

FIG. 8 is a block diagram of an example programmable circuitry platform 800 structured to execute and/or instantiate the example machine-readable instructions and/or the example operations of FIGS. 5-7 to implement the media engine power controller 185 of FIGS. 1 and/or 4. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, VPUs, DSPs, and/or microcontrollers from any desired family or manufacturer. The programmable circuitry 812 may be implemented by one or more semiconductor based (e.g., silicon based) devices. In this example, the programmable circuitry 812 implements the example human presence detector 190 and the example media playback power controller 195 of the media engine power controller 185, which may include the example human interface event detector 405, the example human interface timeout detector 410, the example human face event detector 415, the example human engagement detector 420, the example media playback detector 425 and/or the example presence-based power controller 430.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 832, which may be implemented by the machine-readable instructions of FIGS. 5-7, may be stored in the mass storage device 828, in the volatile memory 814, in the non-volatile memory 816, and/or on at least one non-transitory computer-readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 5-7 to effectively instantiate the circuitry of FIG. 4 as logic circuits to perform operations corresponding to those machine-readable instructions. In some such examples, the circuitry of FIG. 4 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine-readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine-readable instructions and/or operations represented by the flowcharts of FIGS. 5-7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine-readable instructions. However, once configured, the FPGA circuitry 1000 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine-readable instructions represented by the flowchart(s) of FIGS. 5-7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 5-7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5-7. As such, the FPGA circuitry 1000 may be configured and/or structured to effectively instantiate some or all of the operations/functions corresponding to the machine-readable instructions of the flowchart(s) of FIGS. 5-7 as dedicated logic circuits to perform the operations/functions corresponding to those software instructions in a dedicated manner analogous to an ASIC. Therefore, the FPGA circuitry 1000 may perform the operations/functions corresponding to the some or all of the machine-readable instructions of FIGS. 5-7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine-readable instructions of FIGS. 5-7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine-readable instructions represented by the flowchart(s) of FIGS. 5-7 to perform first operation(s)/function(s), the FPGA circuitry 1000 of FIG. 10 may be configured and/or structured to perform second operation(s)/function(s) corresponding to a second portion of the machine-readable instructions represented by the flowcharts of FIG. 5-7, and/or an ASIC may be configured and/or structured to perform third operation(s)/function(s) corresponding to a third portion of the machine-readable instructions represented by the flowcharts of FIGS. 5-7.

It should be understood that some or all of the circuitry of FIG. 4 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 4 may be instantiated, for example, in one or more threads executing concurrently and/or in series. For example, the microprocessor 900 of FIG. 9 may execute machine-readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 4 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

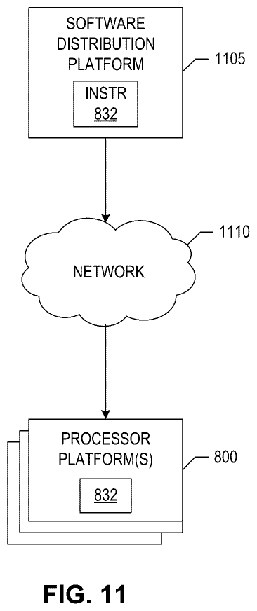

A block diagram illustrating an example software distribution platform 1105 to distribute software such as the example machine-readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine-readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine-readable instructions 832, which may correspond to the example machine-readable instructions of FIGS. 5-7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 832 from the software distribution platform 1105. For example, the software, which may correspond to the example machine-readable instructions of FIG. 5-7, may be downloaded to the example programmable circuitry platform 800, which is to execute the machine-readable instructions 832 to implement the media engine power controller 185. In some examples, one or more servers of the software distribution platform 1105 periodically offer, transmit, and/or force updates to the software (e.g., the example machine-readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that control power usage of a compute device during media playback. Disclosed systems, apparatus, articles of manufacture, and methods improve the efficiency of using a computing device by implementing power control during media playback based on whether a valid human presence is detected, which may be based on detecting a human is present and the human is engaged with the media playback. Example power control solution disclosed herein can cause media engine circuitry of the compute device to transition to a low power state and conserve power based on a negative human presence status associated with the compute device (e.g., a determination that a human is not present or is not engaged with the media playback), thereby enhancing the power efficiency of the compute device. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes a compute device comprising media engine circuitry to process media data to be provided to a display device, machine-readable instructions, and at least one programmable circuit to detect a media playback status of the compute device, obtain a human presence status associated with the compute device, and control a power state of the media engine circuitry based on the media playback status and the human presence status.

Example 2 includes the compute device of example 1, wherein one or more of the at least one programmable circuit is to cause the media engine circuitry to operate in a low power state based on the media playback status indicating media playback is active and the human presence status indicating a valid human presence has not been detected.

Example 3 includes the compute device of example 2, wherein media data includes video data, and the media engine circuitry is to maintain video frame timing during operation in the low power state, and drop video frames to be provided to the display device.

Example 4 includes the compute device of example 2 or example 3, wherein the media engine circuitry includes decoder circuitry, post-processor circuitry and display buffer circuitry, and during operation in the low power state, the decoder circuitry is to be enabled and at least the post-processor circuitry is to be disabled.

Example 5 includes the compute device of example 1, wherein one or more of the at least one programmable circuit is to cause the media engine circuitry to operate in an active power state based on the media playback status indicating media playback is active and the human presence status indicating a valid human presence has been detected.

Example 6 includes the compute device of any one of examples 1 to 5, wherein one or more of the at least one programmable circuit is to detect the media playback status based on detection of media data provided from an active application to the media engine circuitry.

Example 7 includes the compute device of any one of examples 1 to 6, wherein one or more of the at least one programmable circuit is to determine the human presence status based on at least one of a human interface event status or a face detection event status associated with the compute device.

Example 8 includes the compute device of example 7, wherein one or more of the at least one programmable circuit is to set the human presence status to indicate a valid human presence has been detected based on the human interface event status indicating a human interface event has been generated within a timeout period.

Example 9 includes the compute device of example 8, wherein the human interface event is generated based on activity associated with a user interface device associated with the compute device.

Example 10 includes the compute device of example 7, wherein one or more of the at least one programmable circuit is to set the human presence status to indicate a valid human presence has been detected based on the face detection event status indicating a face has been detected in camera data associated with the compute device and the face satisfies an engagement condition.

Example 11 includes the compute device of example 10, wherein the one or more of the at least one programmable circuit is to determine the face satisfies the engagement condition based on an orientation of the face satisfying an engagement angle relative to a camera associated with the camera data.

Example 12 includes the compute device of example 10 or example 11, wherein one or more of the at least one programmable circuit is to obtain the face detection event status after a determination that a timeout period associated with human interface events has expired.

Example 13 includes at least one non-transitory machine-readable storage medium comprising instructions to cause at least one programmable circuit to at least determine a media playback status of a compute device, determine a human presence status associated with the compute device, and configure a power state of media engine circuitry of the compute device based on the media playback status and the human presence status.

Example 14 includes the at least one non-transitory machine-readable storage medium of example 13, wherein the instructions are to cause one or more of the at least one programmable circuit to configure the media engine circuitry to operate in a low power state based on the media playback status indicating media playback is active and the human presence status indicating human presence detection is positive, and configure the media engine circuitry to operate in an active state based on the media playback status indicating media playback is active and the human presence status indicating human presence detection is negative.

Example 15 includes the at least one non-transitory machine-readable storage medium of example 14, wherein the instructions are to cause one or more of the at least one processor circuit to determine the human presence status is positive based on a determination that at least one of (i) a human interface event associated with the compute device has been generated within a timeout period, or (ii) a face associated with the compute device has been detected and the face satisfies an engagement condition, and determine the human presence status is negative based on a determination that no human interface event has been generated within the timeout period and no face that satisfies the engagement condition has been detected in association with the compute device.

Example 16 includes the at least one non-transitory machine-readable storage medium of any one of examples 13 to 15, wherein the instructions are to cause one or more of the at least one processor circuit to determine the media playback status based on a determination of whether media data has been provided from an active application of the compute device to the media engine circuitry.

Example 17 includes a system comprising means for determining a human presence status associated with a compute device, and means for controlling a power state of media engine circuitry of the compute device based on the human presence status and a media playback status of a compute device.

Example 18 includes the system of example 17, wherein the means for controlling is to cause the media engine circuitry to operate in a low power state based on the media playback status indicating media playback is active and the human presence status indicating human presence detection is positive, and cause the media engine circuitry to operate in an active state based on the media playback status indicating media playback is active and the human presence status indicating human presence detection is negative.

Example 19 includes the system of example 18, wherein the means for determining is to determine the human presence status is positive based on a determination that at least one of (i) a human interface event associated with the compute device has been generated within a timeout period, or (ii) a face associated with the compute device has been detected and the face satisfies an engagement condition, and determine the human presence status is negative based on a determination that no human interface event has been generated within the timeout period and no face that satisfies the engagement condition has been detected in association with the compute device.

Example 20 includes the system of any one of examples 17 to 19, wherein the means for controlling is to determine the media playback status based on a determination of whether media data has been provided from an active application of the compute device to the media engine circuitry.

Example 21 includes a method comprising detecting a media playback status of a compute device, obtaining a human presence status associated with the compute device, and controlling a power state of media engine circuitry of the compute device based on the media playback status and the human presence status, the media engine circuitry to process media data to be provided to a display device.

Example 22 includes the method of example 21, wherein the controlling of the power state of the media engine circuitry includes causing the media engine circuitry to operate in a low power state based on the media playback status indicating media playback is active and the human presence status indicating a valid human presence has not been detected.

Example 23 includes the method of example 22, wherein media data includes video data, and the media engine circuitry is to maintain video frame timing during operation in the low power state, and drop video frames to be provided to the display device.

Example 24 includes the method of example 22 or example 23, wherein the media engine circuitry includes decoder circuitry, post-processor circuitry and display buffer circuitry, and during operation in the low power state, the decoder circuitry is to be enabled and at least the post-processor circuitry is to be disabled.

Example 25 includes the method of example 21, wherein the controlling of the power state of the media engine circuitry includes causing the media engine circuitry to operate in an active power state based on the media playback status indicating media playback is active and the human presence status indicating a valid human presence has been detected.

Example 26 includes the method of any one of examples 21 to 25, wherein the detecting of the media playback status is based on detection of media data provided from an active application to the media engine circuitry.

Example 27 includes the method of any one of examples 21 to 26, including determining the human presence status based on at least one of a human interface event status or a face detection event status associated with the compute device.

Example 28 includes the method of example 27, wherein the determining of the human presence status includes setting the human presence status to indicate a valid human presence has been detected based on the human interface event status indicating a human interface event has been generated within a timeout period.

Example 29 includes the method of example 28, wherein the human interface event is generated based on activity associated with a user interface device associated with the compute device.

Example 30 includes the method of example 27, wherein the determining of the human presence status includes setting the human presence status to indicate a valid human presence has been detected based on the face detection event status indicating a face has been detected in camera data associated with the compute device and the face satisfies an engagement condition.

Example 31 includes the method of example 30, including determining the face satisfies the engagement condition based on an orientation of the face satisfying an engagement angle relative to a camera associated with the camera data.

Example 32 includes the method of example 30 or example 31, including obtaining the face detection event status after a determination that a timeout period associated with human interface events has expired.

Example 33 includes at least one machine-readable medium comprising machine-readable instructions to cause at least one programmable circuit to perform the method of any one of examples 21 to 32.

Example 34 includes an apparatus to perform the method of any one of examples 21 to 32.

Example 35 includes a method performed by any one of the compute devices of examples 1 to 12.

Example 36 includes at least one machine-readable medium comprising the machine-readable instructions of any one of the compute devices of examples 1 to 12.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A compute device comprising:
media engine circuitry to process media data to be provided to a display device;
machine-readable instructions; and
at least one programmable circuit to:
detect a media playback status of the compute device;
obtain a human presence status associated with the compute device; and
control a power state of the media engine circuitry based on the media playback status and the human presence status.

2. The compute device of claim 1, wherein one or more of the at least one programmable circuit is to cause the media engine circuitry to operate in a low power state based on the media playback status indicating media playback is active and the human presence status indicating a valid human presence has not been detected.

3. The compute device of claim 2, wherein media data includes video data, and the media engine circuitry is to:
maintain video frame timing during operation in the low power state; and
drop video frames to be provided to the display device.

4. The compute device of claim 2, wherein the media engine circuitry includes decoder circuitry, post-processor circuitry and display buffer circuitry, and during operation in the low power state, the decoder circuitry is to be enabled and at least the post-processor circuitry is to be disabled.

5. The compute device of claim 1, wherein one or more of the at least one programmable circuit is to cause the media engine circuitry to operate in an active power state based on the media playback status indicating media playback is active and the human presence status indicating a valid human presence has been detected.

6. The compute device of claim 1, wherein one or more of the at least one programmable circuit is to detect the media playback status based on detection of media data provided from an active application to the media engine circuitry.

7. The compute device of claim 1, wherein one or more of the at least one programmable circuit is to determine the human presence status based on at least one of a human interface event status or a face detection event status associated with the compute device.

8. The compute device of claim 7, wherein one or more of the at least one programmable circuit is to set the human presence status to indicate a valid human presence has been detected based on the human interface event status indicating a human interface event has been generated within a timeout period.

9. The compute device of claim 8, wherein the human interface event is generated based on activity associated with a user interface device associated with the compute device.

10. The compute device of claim 7, wherein one or more of the at least one programmable circuit is to set the human presence status to indicate a valid human presence has been detected based on the face detection event status indicating a face has been detected in camera data associated with the compute device and the face satisfies an engagement condition.

11. The compute device of claim 10, wherein the one or more of the at least one programmable circuit is to determine the face satisfies the engagement condition based on an orientation of the face satisfying an engagement angle relative to a camera associated with the camera data.

12. The compute device of claim 10, wherein one or more of the at least one programmable circuit is to obtain the face detection event status after a determination that a timeout period associated with human interface events has expired.

13. At least one non-transitory machine-readable storage medium comprising instructions to cause at least one programmable circuit to at least:
determine a media playback status of a compute device;
determine a human presence status associated with the compute device; and
configure a power state of media engine circuitry of the compute device based on the media playback status and the human presence status.

14. The at least one non-transitory machine-readable storage medium of claim 13, wherein the instructions are to cause one or more of the at least one programmable circuit to:
configure the media engine circuitry to operate in a low power state based on the media playback status indicating media playback is active and the human presence status indicating human presence detection is positive; and
configure the media engine circuitry to operate in an active state based on the media playback status indicating media playback is active and the human presence status indicating human presence detection is negative.

15. The at least one non-transitory machine-readable storage medium of claim 14, wherein the instructions are to cause one or more of the at least one processor circuit to:
determine the human presence status is positive based on a determination that at least one of (i) a human interface event associated with the compute device has been generated within a timeout period, or (ii) a face associated with the compute device has been detected and the face satisfies an engagement condition; and
determine the human presence status is negative based on a determination that no human interface event has been generated within the timeout period and no face that satisfies the engagement condition has been detected in association with the compute device.

16. The at least one non-transitory machine-readable storage medium of claim 13, wherein the instructions are to cause one or more of the at least one processor circuit to determine the media playback status based on a determination of whether media data has been provided from an active application of the compute device to the media engine circuitry.

17. A system comprising:
means for determining a human presence status associated with a compute device; and
means for controlling a power state of media engine circuitry of the compute device based on the human presence status and a media playback status of a compute device.

18. The system of claim 17, wherein the means for controlling is to:
cause the media engine circuitry to operate in a low power state based on the media playback status indicating media playback is active and the human presence status indicating human presence detection is positive; and
cause the media engine circuitry to operate in an active state based on the media playback status indicating media playback is active and the human presence status indicating human presence detection is negative.

19. The system of claim 18, wherein the means for determining is to:
determine the human presence status is positive based on a determination that at least one of (i) a human interface event associated with the compute device has been generated within a timeout period, or (ii) a face associated with the compute device has been detected and the face satisfies an engagement condition; and
determine the human presence status is negative based on a determination that no human interface event has been generated within the timeout period and no face that satisfies the engagement condition has been detected in association with the compute device.

20. The system of claim 17, wherein the means for controlling is to determine the media playback status based on a determination of whether media data has been provided from an active application of the compute device to the media engine circuitry.
